(19) United States
(12) Patent Application Publication
(10) Pub. No.: US 2019/0249554 A1
(43) Pub. Date: Aug. 15, 2019

(54) ENGINE COMPONENT WITH COOLING HOLE

(71) Applicant: GENERAL ELECTRIC COMPANY, Schenectady, NY (US)

(72) Inventors: Gregory Terrence Garay, West Chester, OH (US); Tingfan Pang, West Chester, OH (US); Helen Ogbazion Gabregiorgish, San Francisco, CA (US); Zachary Daniel Webster, Mason, OH (US); Steven Robert Brassfield, Cincinnati, OH (US)

(21) Appl. No.: 15/895,157

(22) Filed: Feb. 13, 2018

(51) Int. Cl. F01D 5/18; F01D 9/04; F01D 25/12

(52) U.S. Cl. CPC F01D 5/187; F01D 9/041; F01D 25/12; F05D 2260/202; F05D 2240/303; F05D 2240/121; F05D 2220/323

(57) ABSTRACT

An apparatus and method for an engine component for a turbine engine comprising an outer wall bounding an interior and defining a pressure side and an opposing suction side, with both sides extending between a leading edge and a trailing edge to define a chord-wise direction, and extending between a root and a tip to define a span-wise direction, at least one cooling passage located within the interior, at least one cooling hole having an inlet fluidly coupled to the cooling passage, an outlet located proximate the leading edge, with a connecting passage fluidly coupling the inlet to the outlet.

### BACKGROUND OF THE INVENTION

Turbine engines, and particularly gas or combustion turbine engines, are rotary engines that extract energy from a flow of combusted gases passing through the engine onto a multitude of rotating turbine blades, which can be arranged in multiple turbine blade assemblies.

In one configuration, turbine blade assemblies include the turbine airfoil, such as a stationary vane or rotating blade, with the blade having a platform and a dovetail mounting portion. The turbine blade assembly includes cooling inlet passages as part of serpentine circuits in the platform and blade used to cool the platform and blade. The serpentine circuits can extend to cooling holes located along any of the multiple surfaces of the blade including at the tip, trailing edge, and leading edge.

Nozzles comprising stationary vanes located between inner and outer bands and combustor liners surrounding the combustor of the engine can also utilize cooling holes and/or serpentine circuits.

### BRIEF DESCRIPTION OF THE INVENTION

In one aspect, the present disclosure relates to an airfoil for a turbine engine, the airfoil comprising an outer wall defining an interior having a pressure side and a suction side extending axially between a leading edge and a trailing edge defining a chord-wise direction and extending radially between a root and a tip defining a span-wise direction, a cooling passage located within the interior and proximate the leading edge; and at least one cooling hole comprising an inlet fluidly coupled to the cooling passage and an outlet at the outer wall along the leading edge and having a connecting passage defining a centerline and extending between the inlet and the outlet, with a diffusing section formed in the connecting passage and defining the outlet, wherein the outlet has a non-circular shape and defines a minor axis aligned within +/−30 degrees of the span-wise direction.

In another aspect, the present disclosure relates to an engine component for a turbine engine, the engine component comprising an outer wall defining an interior having a pressure side and a suction side extending axially between a leading edge and a trailing edge defining a chord-wise direction and extending radially between a root and a tip defining a span-wise direction, a cooling passage located within the interior and proximate the leading edge, and at least one cooling hole comprising an inlet fluidly coupled to the cooling passage and an outlet at the outer wall along the leading edge and having a connecting passage defining a centerline and extending between the inlet and the outlet, with a diffusing section formed in the connecting passage and defining the outlet, wherein the outlet has a non-circular shape and defines a minor axis aligned within +/−30 degrees of the span-wise direction.

In yet another aspect, the present disclosure relates to a method of cooling an engine component extending between a leading edge and a trailing edge defining a chord-wise direction and extending radially between a root and a tip defining a span-wise direction, the method comprising flowing a cooling fluid through at least one cooling hole having a non-circular cross-sectional area, emitting a cooling fluid defining a streamline from an outlet located along a stagnation line proximate the leading edge, and directing the cooling fluid toward the trailing edge such that the streamline forms an acute angle with the stagnation line.

### BRIEF DESCRIPTION OF THE DRAWINGS

In the drawings:

FIG. 1 is a schematic cross-sectional diagram of a turbine engine for an aircraft.

FIG. 2 is a perspective view of a turbine blade for the turbine engine from FIG. 1 including at least one cooling hole located along a leading edge of the turbine blade.

FIG. 3 is a cross-section of the turbine blade from FIG. 2 taken along line III-III.

FIG. 4 is an enlarged view a portion of the turbine blade from FIG. 2 showing the at least one cooling hole at the leading edge proximate a root of the turbine blade.

FIG. 5 is a 3D view of a cooling hole geometry of the at least one cooling hole from FIG. 4 illustrating a cross-sectional area according to an aspect of the disclosure herein.

FIG. 6 is a variation of the cross-sectional area of the at least one cooling hole from FIG. 5 according to another aspect of the disclosure herein.

FIG. 7 is a variation of the cross-sectional area of FIG. 5 according to yet another aspect of the disclosure discussed herein.

FIG. 8 is the same as FIG. 4 illustrating a method for cooling the turbine blade.

FIG. 9 is an enlarged view of a portion of the turbine blade from FIG. 2 showing a variation of the at least one cooling hole at the leading edge proximate a root of the turbine blade according to another aspect of the disclosure herein.

### DETAILED DESCRIPTION OF THE INVENTION

Aspects of the disclosure described herein are directed to the formation of at least one cooling hole having an inlet fluidly coupled to a cooling passage and an outlet located along a leading edge of an engine component. For purposes of illustration, the present disclosure will be described with respect to a turbine blade in the turbine for an aircraft gas turbine engine. It will be understood, however, that aspects of the disclosure described herein are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component. Additionally, as used herein, the terms “radial” or “radially” refer to a dimension extending between a center longitudinal axis of the engine and an outer engine circumference. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

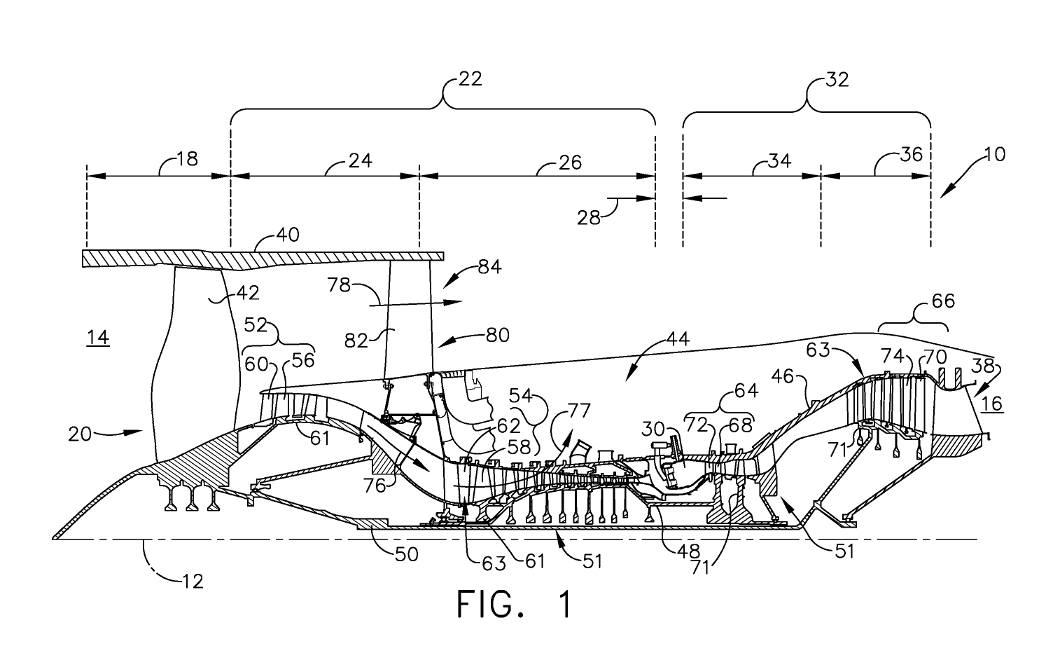

FIG. 1 is a schematic cross-sectional diagram of a gas turbine engine 10 for an aircraft. The engine 10 has a generally longitudinally extending axis or engine centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the engine centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the engine centerline 12 of the engine 10 drivingly connects the HP turbine 34 to the HP compressor 26. ALP shaft or spool 50, which is disposed coaxially about the engine centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the engine centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the engine centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine sections 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

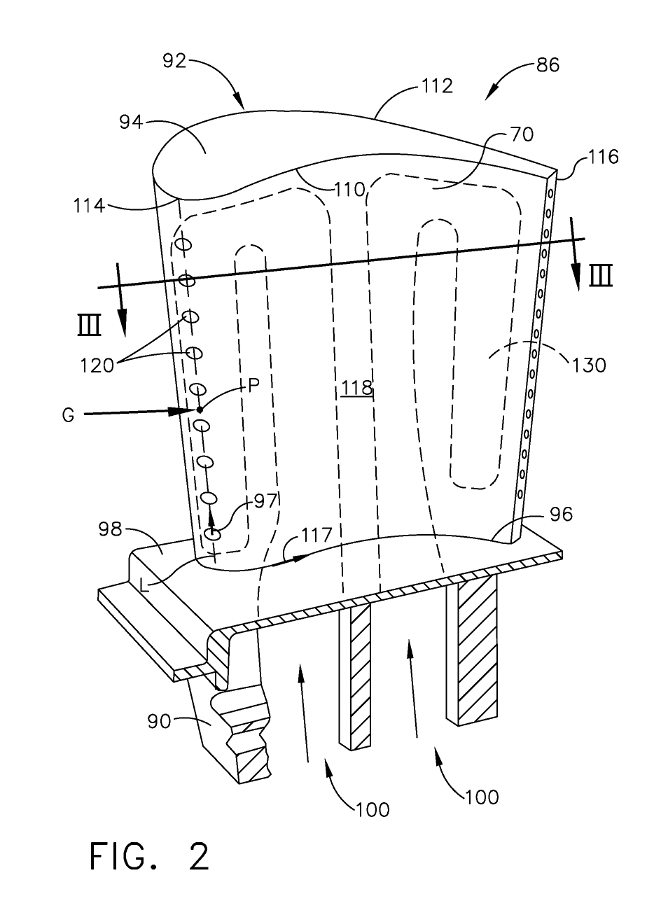

FIG. 2 is a perspective view of an engine component in the form of a turbine blade assembly 86 with a turbine blade 70 of the engine 10 from FIG. 1. Alternatively, the engine component can include a vane, a strut, a service tube, a shroud, or a combustion liner in non-limiting examples, or any other engine component that can require or utilize cooling passages.

The turbine blade assembly 86 includes a dovetail 90 and an airfoil 92. The airfoil 92 extends between a tip 94 and a root 96 to define a span-wise direction 97. The airfoil 92 mounts to the dovetail 90 on a platform 98 at the root 96. When multiple airfoils are circumferentially arranged in side-by-side relationship, the platforms 98 help to radially contain the turbine engine mainstream air flow. The dovetail 90 can be configured to mount to the turbine rotor disk 71 on the engine 10. The dovetail 90 further includes at least one inlet passage 100, exemplarily shown as two inlet passages 100, each extending through the dovetail 90 to provide internal fluid communication with the airfoil 92. It should be appreciated that the dovetail 90 is shown in cross-section, such that the inlet passages 100 are housed within the body of the dovetail 90.

The airfoil 92 includes a concave-shaped pressure side 110 and a convex-shaped suction side 112 which are joined together to define an airfoil cross-sectional shape of the airfoil 92 extending between a leading edge 114 and a trailing edge 116 to define a chord-wise direction 117. An outer periphery of the airfoil 92 is bound by an outer wall 118, which also defines the pressure and suction sides 110, 112. The interior of the airfoil can be solid, hollow, and/or having multiple cooling circuits or passages 130 illustrated in dashed line. At least one cooling hole 120 can be located along any portion of the outer wall 118 including along the leading edge 114 as illustrated.

In operation when a flow of combusted gases (G) contacts the airfoil 92 at an angle of ninety degrees, the velocity of the combusted gases (G) is zero at this stagnation point (P). The stagnation point (P) can vary a certain degree along the leading edge 114 extending from the root 96 to the tip 94. It is contemplated that the at least one cooling hole 120 is located along a stagnation line (L) extending from the root 96 to the tip 94 connecting stagnation points (P). In most cases the stagnation line (L) is co-linear with leading edge. However, the stagnation line (L) can temporarily or permanently vary from all or part of the leading edge 114 during all or part of the operational conditions.

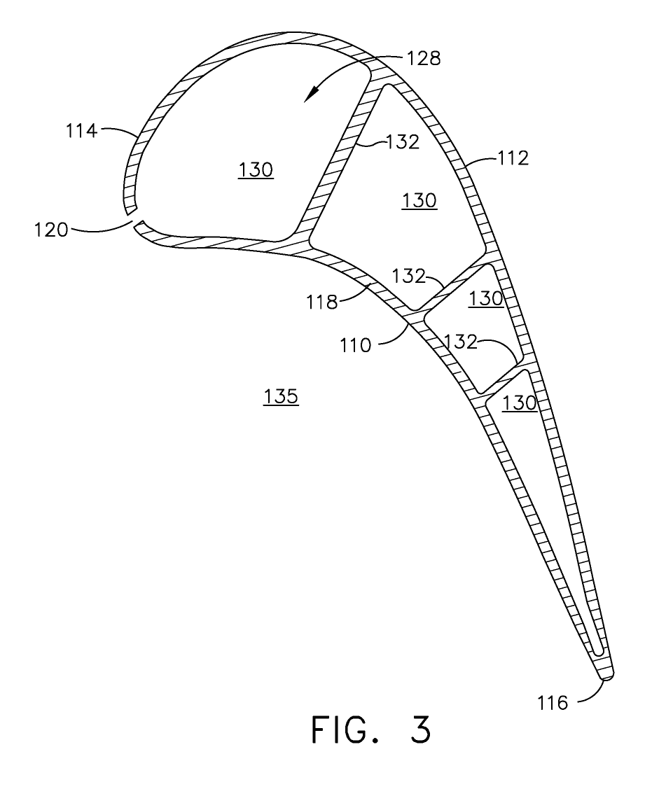

Turning to FIG. 3 an interior 128 of the airfoil 92 is bound by outer wall 118 and can include multiple cooling passages 130. The multiple cooling passages 130 can be fluidly coupled with at least one of the inlet passages 100 (FIG. 2). Pin fins, dimples, turbulators, or any other type of flow enhancer can be provided along an interior surface of the multiple cooling passages 130. The multiple cooling passages 130 can be separated by interior walls 132. Interior walls 132 can extend between the pressure and suction sides as illustrated, and in other non-limiting examples can be any wall within the airfoil and defining at least a portion of the multiple cooling passages 130. The at least one cooling hole 120 can fluidly couple the interior 128 of the airfoil 92 to an exterior 135 of the airfoil 92.

The at least one cooling hole 120 can pass through a substrate, which by way of illustration is outer wall 118. It should be understood, however, that the substrate can be any wall within the engine 10 including but not limited to the interior walls 132, a tip wall, or a combustion liner wall. Materials used to form the substrate include, but are not limited to, steel, refractory metals such as titanium, or superalloys based on nickel, cobalt, or iron, and ceramic matrix composites. The superalloys can include those in equiaxed, directionally solidified, and crystal structures. The substrate can be formed by, in non-limiting examples, 3D printing, investment casting, or stamping.

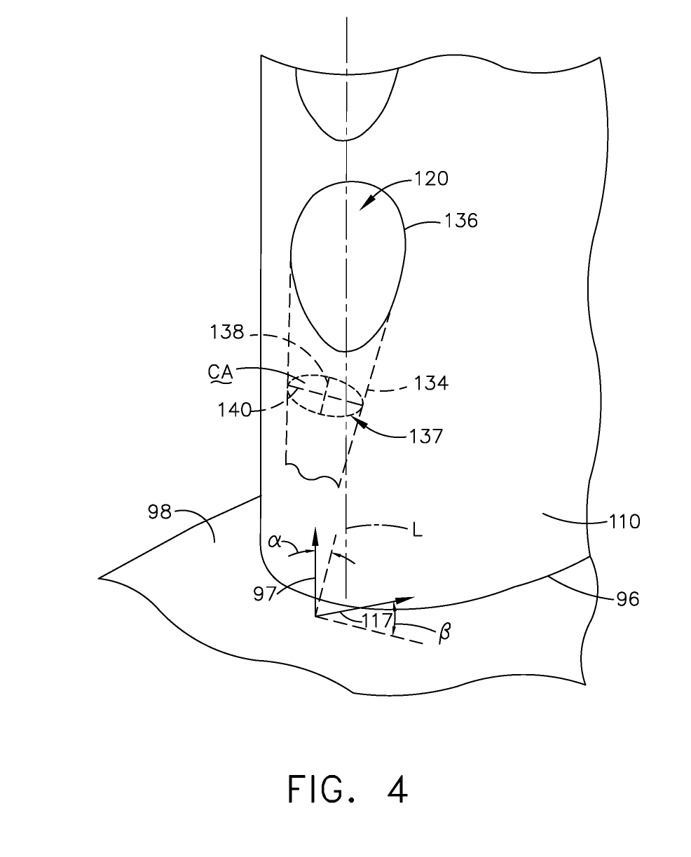

Turning to FIG. 4 an enlarged view of the turbine blade 70 proximate the root 96 at the leading edge 114 includes the at least one cooling hole 120. A cooling hole geometry 134 illustrated in dashed lines extends both in a generally radial direction and into the page from an outlet 136 of the at least one cooling hole 120. Depending on the location of the at least one cooling hole 120 and the thickness of the outer wall 118, the extent to which the at least one cooling hole 120 passes through the outer wall 118 can vary. Depending on the location of the at least one cooling hole 120 along the stagnation line (L), the outlet 136 of the at least one cooling hole 120 may vary in size and shape and may be slightly offset from the stagnation line (L).

A cross-sectional area (CA) of the cooling hole geometry 134 has a non-circular shape, by way of non-limiting example an oval shape 137, defining a minor axis 138 oriented within +/−30 degrees, α, of the span-wise direction 97 and a major axis 140 oriented within +/−30 degrees, β, of the chord-wise direction 117. The minor axis 138 can be the smallest dimension defined by the non-circular cross-sectional area (CA) of the at least one cooling hole 120 while the major axis 140 can be the largest dimension of that same non-circular cross-sectional area (CA). In an aspect of the disclosure herein the major to minor axis ratio could be as much as 15, where the cross-sectional area (CA) shape is a very oblong elliptical shape to promote lateral diffusion. A minimum major to minor axis ratio could be 1.1, with a preferred major to minor axis ratio of 1.7.

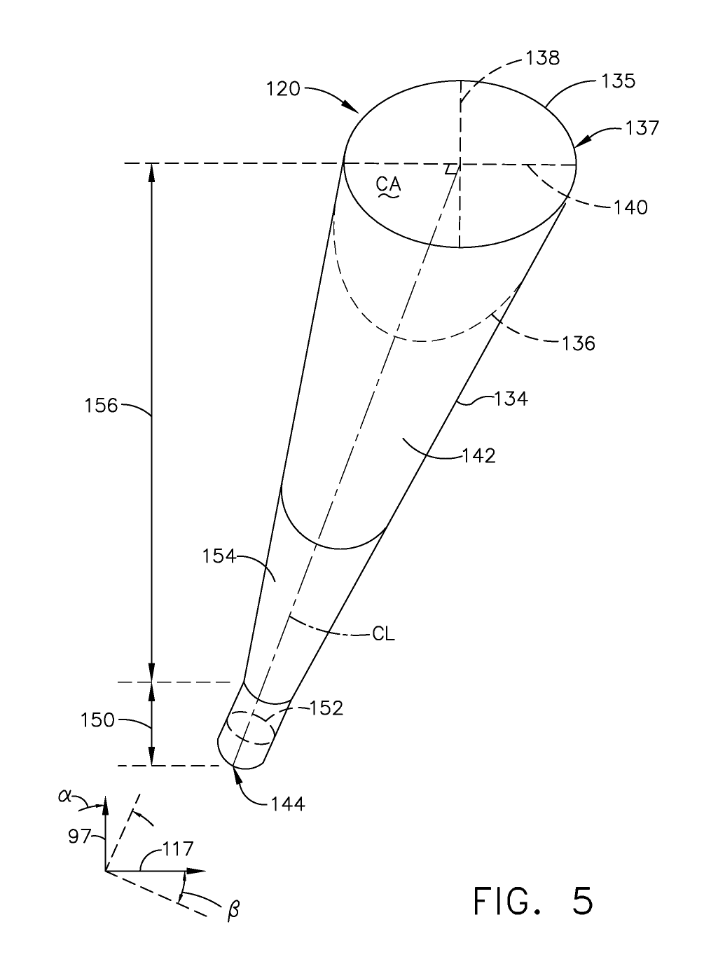

FIG. 5 shows a 3D view of the cooling hole geometry 134 for the at least one cooling hole 120. It should be understood that the cooling hole geometry 134, though illustrated as a solid, represents a void in the engine component as discussed herein. The cross-sectional area (CA) is an area of a plane 139 that is perpendicular to a centerline (CL) of the at least one cooling hole 120. The at least one cooling hole 120 includes a connecting passage 142 extending between an inlet 144 fluidly connected to the cooling passage 130 and the outlet 136 located along the stagnation line (L) at the outer wall 118 of the airfoil 92. It is contemplated that where the at least one cooling hole 120 exists in an engine component substrate, an angled outlet 136 illustrated in dashed lines would be produced.

The connecting passage can include a metering section 150 having a circular cross-sectional area 152, though any cross-sectional shape is contemplated. The metering section 150 can be provided at or near the inlet 144. As illustrated, the metering section 150 defines the smallest cross-sectional area of the connecting passage 142. It should be appreciated that more than one metering section 150 can be formed in the connecting passage 142. The metering section 150 can extend from the inlet 144 to a transition location 154 where the cross-sectional area of the connecting passage 142 begins to increase. It is further contemplated that the metering section 150 has no length and can define the transition location 154.

A diffusing section 156 can be provided at or near the outlet 136 to define a portion of the connecting passage 142. In one exemplary implementation, the diffusing section 156 defines the outlet 136. The non-circular cross-sectional area (CA) as described herein can increase extending from the transitional location 154 toward the outlet 136 to define the diffusing section 156. In one example, the non-circular cross-sectional area (CA) is continuously increasing as illustrated. In one alternative, non-limiting implementation, the increasing non-circular cross-sectional area (CA) can be a discontinuous or step-wise increasing cross-sectional area.

The connecting passage 142 connects the inlet 144 to the outlet 136, through which a cooling fluid (C) can flow. The metering section 150 meters the mass flow rate of the cooling fluid (C). The diffusing section 156 enables an expansion of the cooling fluid (C) to form a wider and slower cooling film along the outer wall 118. In an aspect of the disclosure herein, the diffusing section 156 enables the cooling fluid (C) to diffuse more in the chord-wise direction 117 than the radial direction 97. The diffusing section 156 can be in serial flow communication with the metering section 150. It is alternatively contemplated that the diffusing section 156 extends along the entirety of the at least one cooling hole 120.

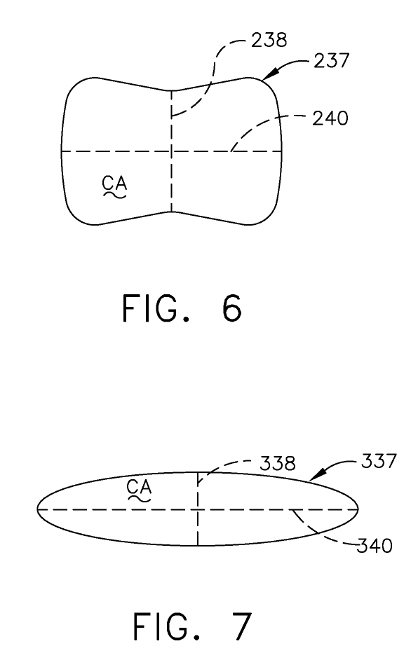

FIG. 6 is a variation of the non-circular cross-sectional area (CA) according to another aspect of the disclosure herein. A dog-bone shape 237 can define a minor axis 238 oriented within +/−30 degrees of the span-wise direction 97 and a major axis 240 oriented within +/−30 degrees of the chord-wise direction 117.

FIG. 7 is a variation of the non-circular cross-sectional area (CA) according to another aspect of the disclosure herein. An ellipse 337 can define a minor axis 338 oriented within +/−30 degrees of the span-wise direction 97 and a major axis 340 oriented within +/−30 degrees of the chord-wise direction 117.

It is further contemplated that the non-circular cross-sectional area (CA) as described herein can be any combination of shapes, oval, dog-bone, or ellipse, or any other shape where a minor axis is oriented within +/−30 degrees of the span-wise direction 97 and a major axis 340 is oriented within +/−30 degrees of the chord-wise direction 117. The shapes described herein are for illustrative purposes and not meant to be limiting.

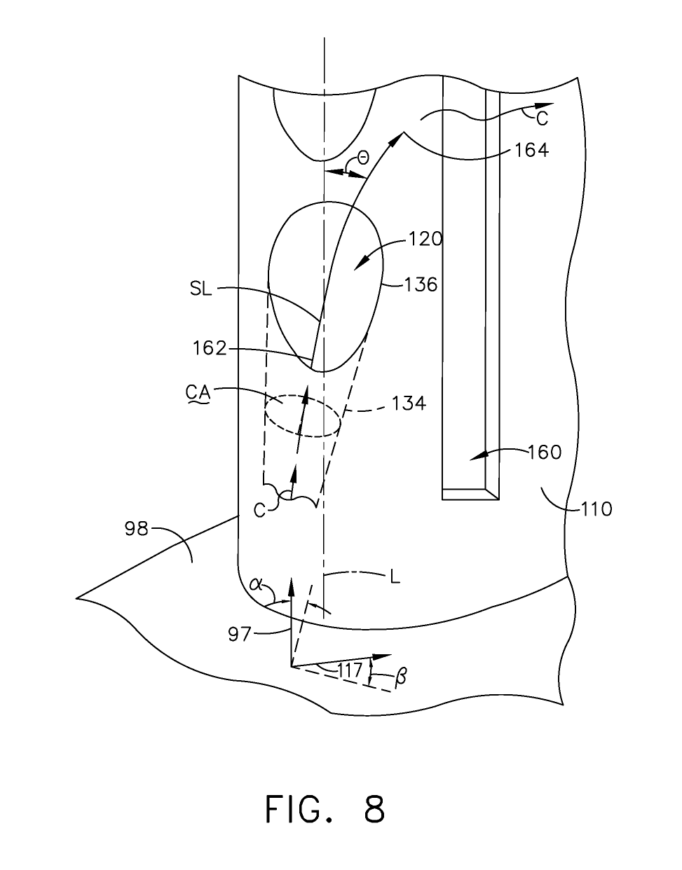

Turning to FIG. 8, a method of cooling the airfoil 92 as described herein can include flowing a cooling fluid (C) through the at least one cooling hole 120 with a non-circular cross-sectional area (CA). Emitting the cooling fluid through the outlet 136 along the stagnation line (L) to define a streamline (SL), by way of non-limiting example along the centerline (CL). Directing the cooling fluid (C) toward the trailing edge 116 (FIG. 2) such that the streamline (SL) forms an acute angle 0 with the stagnation line (L). In an aspect of the disclosure herein, the cooling fluid (C) is emitted from a radially inward location 162 to a radially outward location 164.

In yet another aspect of the disclosure herein, as illustrated in FIG. 8, a trench 160 can extend along one of the pressure or suction sides 110, 112, by way of non-limiting example radially along the pressure side 110 as illustrated. The trench 160 can be proximate the at least one cooling hole 120 where the cooling fluid (C) is emitted onto the outer wall 118 and then passes through the trench 160. The method as described herein can further include passing at least a portion of the cooling fluid (C) through the trench 160 in order to disperse the cooling fluid (C) along the outer wall 118.

As previously stated, the cooling fluid can be bypass air from the air supplied by the fan 20 (FIG. 1). Other sources of cooling fluid are also contemplated. It should also be understood that while cooling fluid (C) is supplied through the inlet passages 100, this is an exemplary inlet and is for illustrative purposes only and not meant to be limiting. By way of non-limiting example in the case of a stationary vane, the cooling fluid (C) can be fed into the airfoil 92 from above as well.

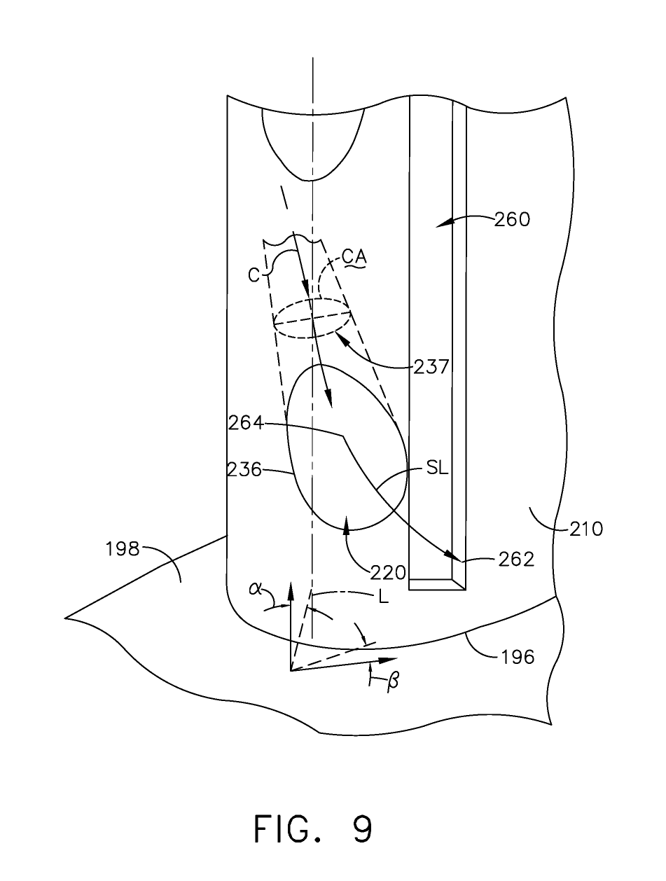

FIG. 9 is a cooling hole 220 according to another aspect of the disclosure discussed herein. The cooling hole 220 is substantially similar to the at least one cooling hole 120. Therefore, like parts will be identified with like numerals increased by 100, with it being understood that the description of the like parts of the at least one cooling hole 120 applies to the cooling hole 220 unless otherwise noted.

In an aspect of the disclosure herein, the cooling hole 220 can be oriented such that cooling fluid (C) is emitted from a radially outward location 262 to a radially inward location 264. It is also contemplated that a trench 260 is coincident with the at least one cooling hole 220 where the cooling fluid (C) is emitted directly into the trench 260.

It should be understood that any combination of the above described geometries with respect to the orientation and location of the cooling holes 120, 220 as described herein are also contemplated. By way of non-limiting example cooling holes could be staggered along the leading edge in alternating patterns where some cooling holes are oriented inversely of other cooling holes. The cooling holes as illustrated herein are for illustrative purposes only and not meant to be limiting.

Benefits associated with the at least one cooling hole as described herein are related to increased coverage of the leading edge and in particular the area surrounding the stagnation line as described herein. More specifically, diffusing the cooling fluid more in the chord-wise direction than in the radial direction enables a better cooling proximate the stagnation line even in the case of small miscalculations with respect to the location of the stagnation line. The angle associated with the stagnation line and the outer wall enable more spreading out of the cooling film and less penetration into any surrounding flow. Coupling the at least one cooling hole with the trench as described herein increases the amount of spreading of the cooling film as well. Commercially better cooling coverage of the area surrounding the stagnation line increases the durability and the life of the engine component.

The sets of cooling holes as described herein can be manufactured utilizing additive manufacturing technologies or other advanced casting manufacturing technologies such as investment casting and 3-D printing and laser drilling and EDM drilling. The technologies available provide cost benefits along with the other benefits described. It should be understood that other methods of forming the cooling circuits and cooling holes described herein are also contemplated and that the methods disclosed are for exemplary purposes only.

It should be appreciated that application of the disclosed design is not limited to turbine engines with fan and booster sections, but is applicable to turbojets and turboprop engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An airfoil for a turbine engine, the airfoil comprising:
an outer wall defining an interior having a pressure side and a suction side extending axially between a leading edge and a trailing edge defining a chord-wise direction and extending radially between a root and a tip defining a span-wise direction;
a cooling passage located within the interior and proximate the leading edge; and
at least one cooling hole comprising an inlet fluidly coupled to the cooling passage and an outlet at the outer wall along the leading edge and having a connecting passage defining a centerline and a cross-sectional area and extending between the inlet and the outlet, with a diffusing section formed in the connecting passage and defining the outlet;
wherein the cross-sectional area has a non-circular shape and defines a minor axis aligned within +/−30 degrees of the span-wise direction.

2. The airfoil of claim 1 wherein the cross-sectional area further defines a major axis and the major axis to minor axis ratio ranges from 15 to 1.1.

3. The airfoil of claim 1 wherein the non-circular shape is at least one of a dog-bone or oval.

4. The airfoil of claim 1 wherein a stagnation line separates the pressure side from the suction side.

5. The airfoil of claim 4 wherein the outlet intersects the stagnation line.

6. The airfoil of claim 4 wherein the stagnation line is co-linear with the leading edge.

7. The airfoil of claim 4 wherein the stagnation line comprises stagnation points along any of the leading edge, pressure side, or suction side.

8. The airfoil of claim 4 wherein the centerline forms an angle with the stagnation line.

9. The airfoil of claim 8 wherein a streamline continuing from the centerline extends towards the trailing edge.

10. The airfoil of claim 1 wherein the cooling passage extends in the span-wise direction.

11. The airfoil of claim 1 further comprising a trench extending radially along one of the pressure or suction sides and located proximate the outlet.

12. The airfoil of claim 1 further comprising a trench extending radially along one of the pressure or suction sides and located coincident with the outlet.

13. An engine component for a turbine engine, the engine component comprising:
an outer wall defining an interior having a pressure side and a suction side extending axially between a leading edge and a trailing edge defining a chord-wise direction and extending radially between a root and a tip defining a span-wise direction;
a cooling passage located within the interior and proximate the leading edge; and
at least one cooling hole comprising an inlet fluidly coupled to the cooling passage and an outlet at the outer wall along the leading edge and having a connecting passage defining a centerline and cross-sectional area and extending between the inlet and the outlet, with a diffusing section formed in the connecting passage and defining the outlet;
wherein the cross-sectional area has a non-circular shape and defines a minor axis aligned within +/−30 degrees of the span-wise direction.

14. The engine component of claim 13 wherein the cross-sectional further defines a major axis and the major axis to minor axis ratio ranges from 15 to 1.1.

15. The engine component of claim 13 wherein a stagnation line separates the pressure side from the suction side.

16. The engine component of claim 15 wherein the outlet intersects the stagnation line.

17. The engine component of claim 15 wherein the stagnation line comprises stagnation points along any of the leading edge, pressure side, or suction side.

18. The engine component of claim 15 wherein the centerline forms an angle with the stagnation line.

19. The engine component of claim 18 wherein a streamline continuing from the centerline extends towards the trailing edge

20. The engine component of claim 13 further comprising a trench extending radially along one of the pressure or suction sides and located proximate the outlet.

21. The engine component of claim 13 further comprising a trench extending radially along one of the pressure or suction sides and located coincident with the outlet.

22. A method of cooling an engine component extending between a leading edge and a trailing edge defining a chord-wise direction and extending radially between a root and a tip defining a span-wise direction, the method comprising:
flowing a cooling fluid through at least one cooling hole having a non-circular cross-sectional area;
emitting a cooling fluid defining a streamline from an outlet located along a stagnation line proximate the leading edge; and
directing the cooling fluid toward the trailing edge such that the streamline forms an acute angle with the stagnation line.

23. The method of claim 22 further comprising directing the cooling fluid into a trench on one of the pressure or suction sides.

24. The method of claim 22 further comprising emitting the cooling fluid from a radially inward location to a radially outward location.

25. The method of claim 22 further comprising emitting the cooling fluid from a radially outward location to a radially inward location.
